(19) United States
(12) Patent Application Publication
(10) Pub. No.: US 2019/0199110 A1
(43) Pub. Date: Jun. 27, 2019

(54) TRANSPORTATION DEVICE STORAGE AND CHARGING

(71) Applicant: Ford Motor Company, Dearborn, MI (US)

(72) Inventors: Kilian VAS, Koln/NRW (DE); Daniel HARI, Koln/NRW (DE); Uwe WAGNER, Wermelskirchen/NRW (DE)

(21) Appl. No.: 16/322,158

(22) PCT Filed: Aug. 2, 2016
(86) PCT No.: PCT/US2016/045098

§ 371 Date: Jan. 31, 2019

(51) Int. Cl. H02J 7/00; A63C 17/12; B60L 53/14

(52) U.S. Cl. CPC H02J 7/0027; B60L 53/14; A63C 17/12

(57) ABSTRACT

A system includes a storage apparatus that includes a charging port, a handling device, and a processor programmed to output a signal to the handling device to select the storage apparatus for a transportation device, place the transportation device in the storage apparatus, and then activate the charging port to charge the transportation device.

### BACKGROUND

With growing population and a shift toward more urbanization, urban population is increasing. Users increasingly ride public transportation systems and walk from public transport stations to final destinations. Moreover, many suburban residents now park their cars in parking structures in city centers and walk to their final destination to avoid traffic congestion of city centers. An improved transportation device and improved infrastructure for such improved transportation devices could support those trends.

### BRIEF DESCRIPTION OF THE DRAWINGS

FIG. 1 is a perspective view of an example transportation device.

FIG. 2 is perspective top view of the device of FIG. 1.

FIG. 3 is perspective bottom view of the device of FIG. 1.

FIG. 4 is a perspective view of an example transportation device with a suspension component.

FIG. 5A is a side view of the device of FIG. 4.

FIG. 5B is a side view of the device of FIG. 4 moving over a small object.

FIG. 6A is a side view of the device of FIG. 1 moving forward and transporting a user.

FIG. 6B is a side view of the device of FIG. 1 moving backward and transporting a user.

FIG. 6C is a rear view of the device of FIG. 1 turning left and transporting a user.

FIG. 7 is a perspective view of the device of FIG. 1 carrying a load and following a user.

FIG. 8 is a perspective view of the device of FIG. 1 illustrating each of a mounted display and a projected display.

FIG. 9 is a perspective view of the device of FIG. 1 stored in a trunk of a vehicle.

FIG. 10 is a block diagram showing electrical components of the device and a mobile computing device.

FIG. 11 is a flowchart of a method for a follow mode for the device of FIG. 1.

FIG. 12 is a perspective view of a storage system for the device of FIG. 1.

FIG. 13 is a detail perspective view of the storage system of FIG. 12.

FIG. 14 is a perspective view of a portion of the storage system of FIG. 12.

FIG. 15 is a block diagrams showing electrical components of the storage system of FIG. 12.

FIG. 16 is a flowchart of a method for the storage system of FIG. 12.

### DETAILED DESCRIPTION

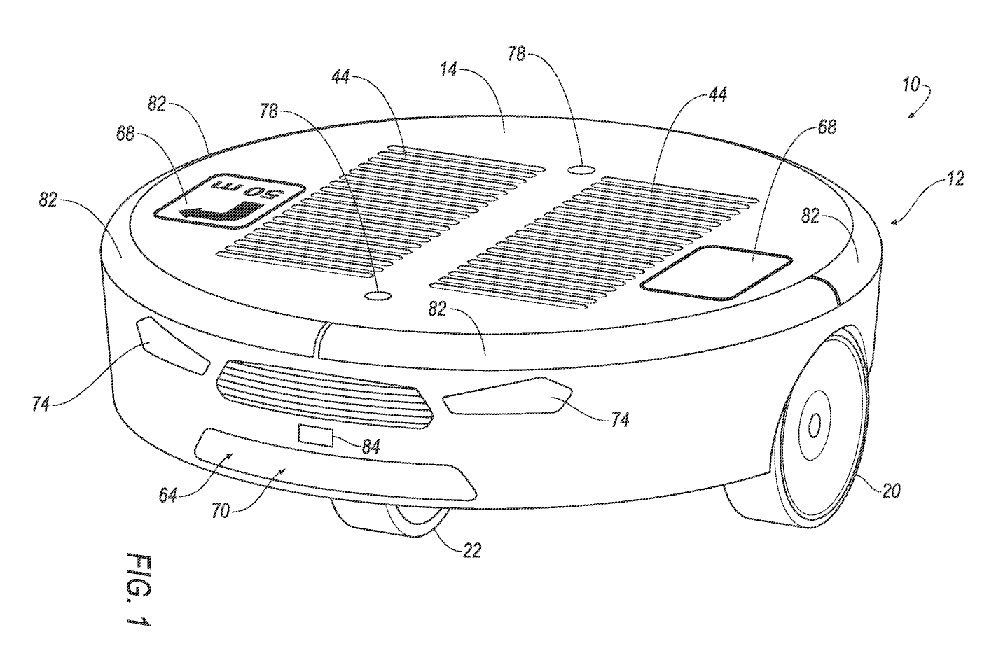

With reference to the Figures, wherein like numerals indicate like parts throughout the several views, with reference to FIGS. 1-11, an example device 10 includes a platform member 12 with a top 14 and a bottom 16, a plurality of wheels 18, 20, 22, 24 each of the wheels rotatably mounted to the bottom 16 of the platform member 12, and a motor 26, 28 mounted to the bottom 16 of the platform member 12, and a drive shaft 30, 32 extending from the motor and drivably coupled to at least one of the wheels 18, 20, 22, 24.

The device 10 may be used by a user as a mobility device. The device 10 may carry the user while the user stands on the top 14 of the device 10. The device 10 accordingly may provide a convenience for the user, for example, when the user needs to travel a long distance in a crowded urban area that the user would otherwise walk. Additionally, the device 10 may be useful to carry a load 34, e.g. a shopping bag or other cargo. The device 10 could carry the load 34 and follow the user as the user walks.

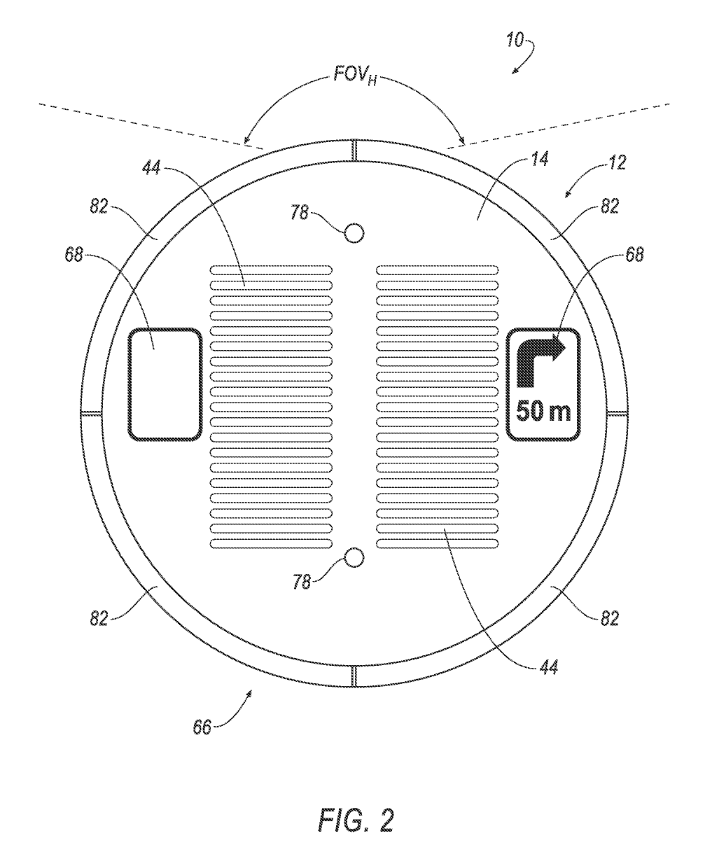

A right wheel 18, a left wheel 20, and a front wheel 22 rotatably mounted to the bottom 16 of the device 10 are shown in FIGS. 1 and 2. The device 10 may move on the ground surface while the wheels 18, 20, 22, 24 rotate. A force to move the device 10 may be provided by the motor drivably coupled to one or more of the wheels. The device 10 typically is able to move in different directions, e.g., forward and backward.

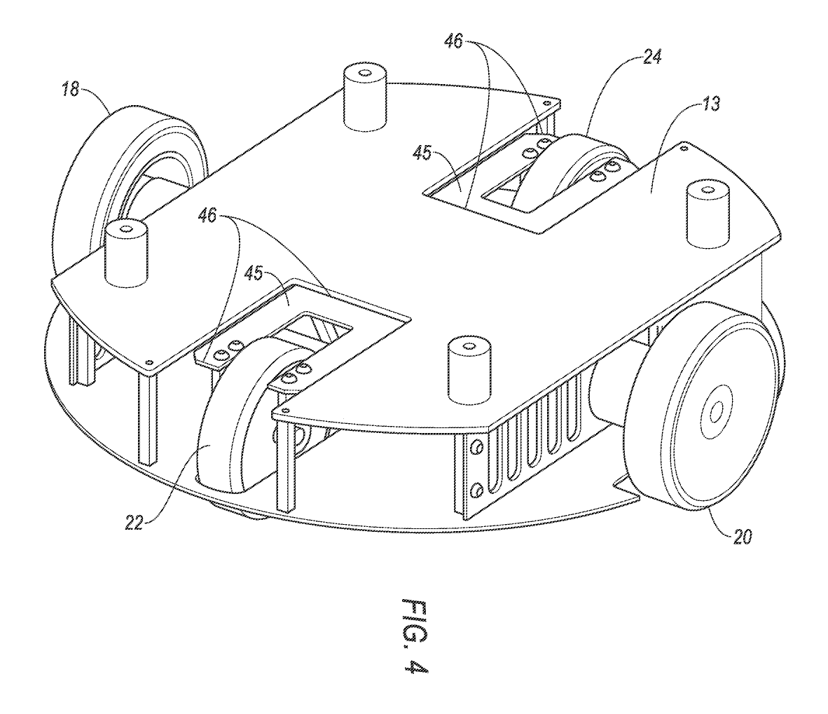

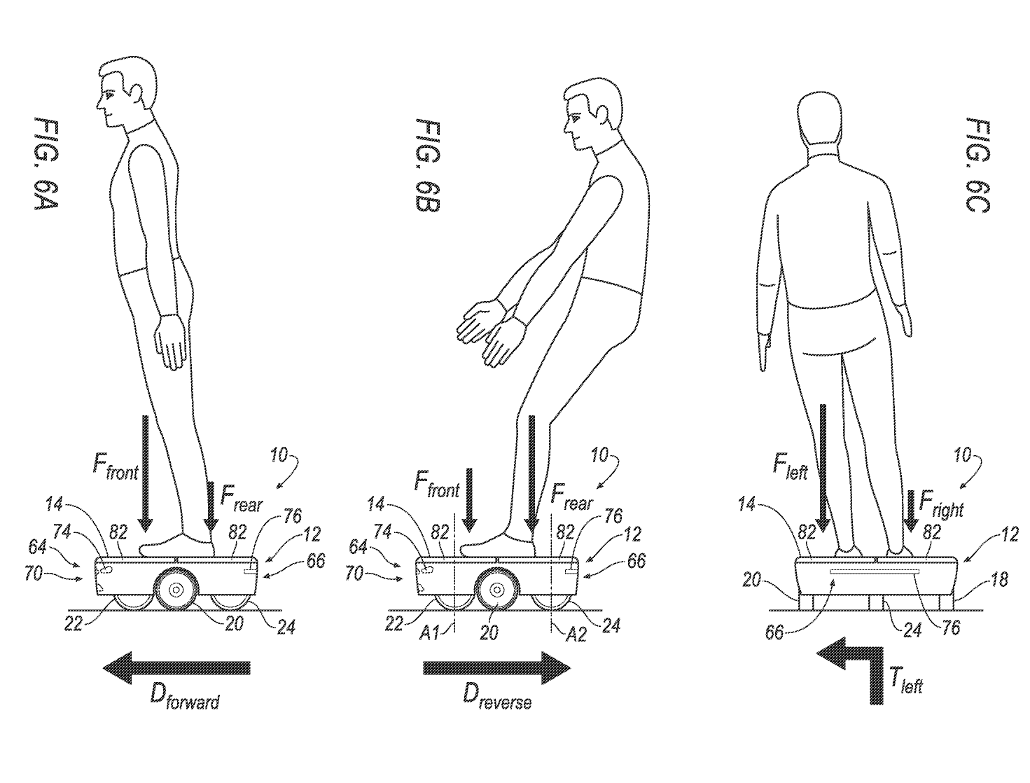

The front wheel 22 may be pivotable about an axis A1 transverse to the platform member 12, as shown in FIG. 6B, or the front wheel 22 may be an omnidirectional, i.e., “Omni” wheel able to slide laterally, as shown in FIG. 4. Omni wheels, as are known, can advantageously provide lateral sliding movements when, e.g., the device 10 turns or negotiates a curve. Omni wheels are for example built as wheels with small discs mounted around the wheel circumference while rotational axes of these small discs are transverse to the rotational axis of the Omni wheel. Omni wheels can, therefore, provide movements in a forward or in a backward direction, but can also slide laterally with ease, i.e., through rotation of the small discs. Alternatively, Omni wheels can be built in any other suitable way to provide sliding movements in lateral direction. Additionally or alternatively, one or more of the wheels 18, 20, 22, 24 may be pivotable wheels, Omni wheels, or pivotable Omni wheels.

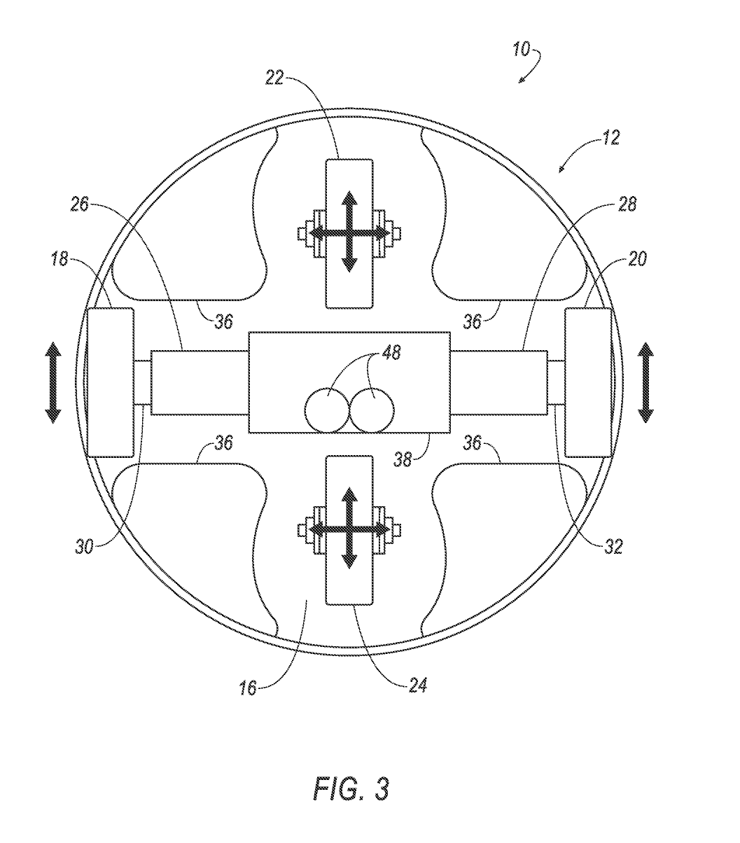

As another example shown in FIGS. 3 and 6B, the device 10 has a rear wheel 24 rotatably mounted to the bottom 16 of the platform member 12. Additionally, the rear wheel 24 may be a wheel pivotable about an axis A2, an Omni wheel, or an Omni wheel pivotable about the axis A2.

As shown in the Figures, the platform member 12 has a substantially circular shape. Alternatively, the platform member 12 may have any other suitable shape. The platform member 12 may include a chassis 13, as shown in FIG. 4. The chassis 13 may include beams, sheets, etc. that are fixed together, e.g., welded. The chassis 13 may be formed of metal, hard plastic, or any other suitable material. The top 14 can be attached to the chassis 13, e.g., with screws.

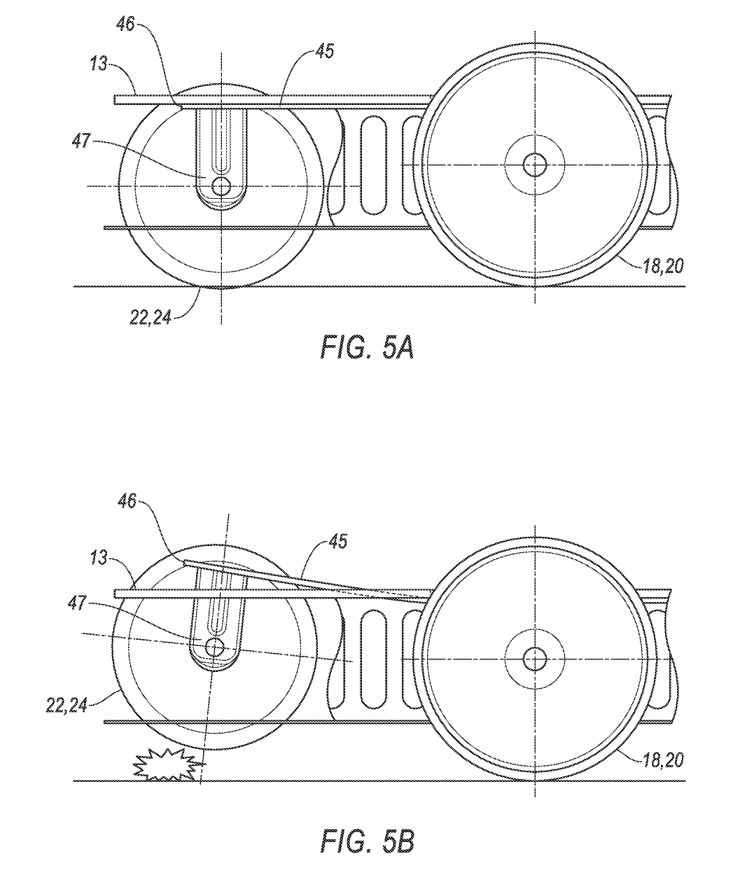

The device 10 may include one or more suspension component(s) 45 mounted to the platform member 12, e.g., chassis 13, as shown in FIGS. 4 and 5, to, e.g., smooth a ride over rough surfaces or objects. The suspension components 45 may have a first end 46 mounted to the chassis 13 and a second end 46 mounted to a wheel 18, 20, 22, 24, e.g., via a wheel attachment member 47. When, e.g., the ground surface is flat, the suspension component 45 may be in a steady state, as shown in FIG. 5A, i.e., the wheel 22, 24 is not moved relative to the chassis 13. Whereas, when, e.g., the device rides over an object or a rough surface, the suspension component 45 can allow a movement of the suspension component 45 second end 46 relative to the first end 46 along an axis transverse to the chassis 13, as shown in FIG. 5B. The suspension component 45 may be a leaf spring, e.g., formed of a flexible steel, which can bend as shown in FIG. 5B.

The motor 26, 28 may be an electric motor. Electrical energy required to operate the electric motor may come from a plurality of batteries 36 mounted to the platform member 12, as shown in FIG. 3. As an example, in order to optimally use the space, four batteries 36 can be mounted at the bottom 16 of the device 10. Additionally, the device 10 may include a second electric motor 28 and a second shaft 32 extending therefrom, the second electric motor 28 mounted to the bottom 16 of the platform member 12 wherein the drive shaft 30 driveably coupled to the right wheel 18, and the second shaft 32 is driveably coupled to the left wheel 20.

As shown in FIG. 3, the device 10 may have an electronic controller 38 mounted to the bottom 16 of the platform member 12 or elsewhere having a processor 40 and a memory, the memory storing instructions executable by the processor 40 to control a steering, speed, acceleration, and/or deceleration of the device 10. Moreover, the device 10 may have one or more batteries 36 mounted to the bottom 16 of the platform member 12 providing electrical energy for the electric motors 26, 28.

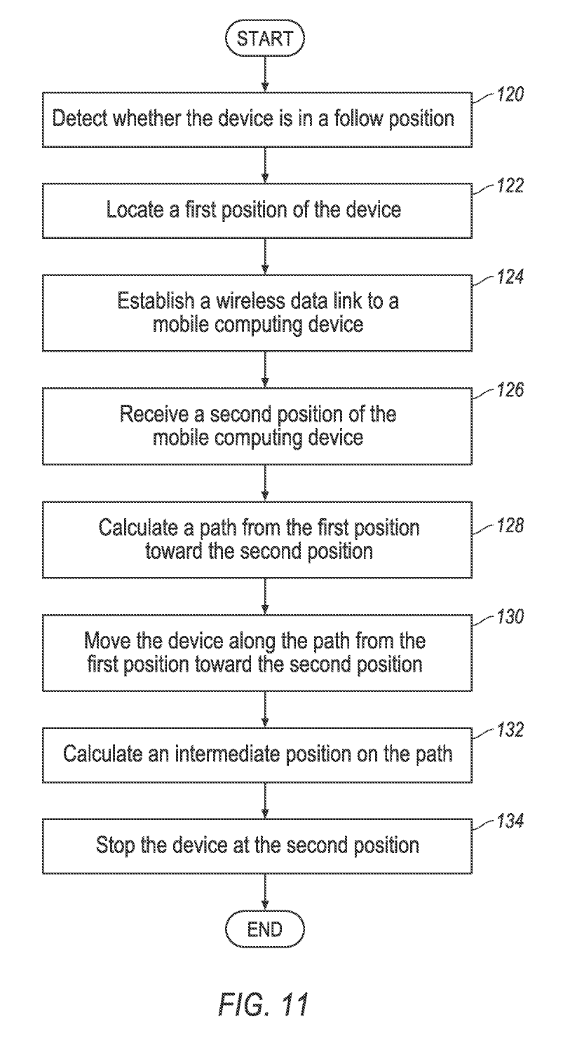

The electronic controller 38 may include a motor drive circuitry 42 as shown in FIG. 11 to control the speed of the electrical motors 26, 28, e.g., a pulse width modulation circuitry. The motor drive circuitry 42 may actuate the motors 26, 28 to accelerate, decelerate, or steer the device 10.

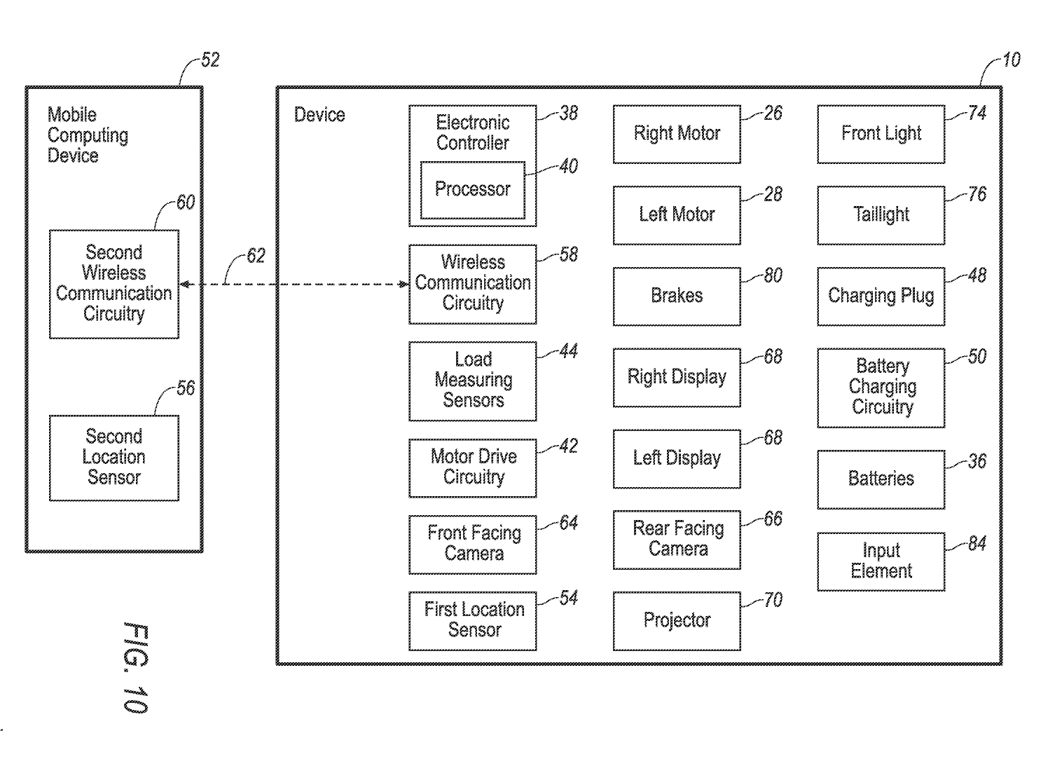

The device 10 may include an input element 84, e.g., a push button or a toggle switch, mounted to, e.g., the platform member 12, to select a mode of operation for the device 10, as shown in FIGS. 1 and 10. The modes of operation can, for example, include a normal mode and an economy mode. The operation of the device 10 in the economy mode may reduce an energy consumption of the electric motors 26, 28 compared to the normal mode. For example, to reduce the energy consumption, in the economy mode a maximum speed of the device 10 may be less than a maximum speed of the device 10 in the normal mode. As an example, the processor 40 may be programmed to receive a signal from the input element 84 and select a mode of operation according to the received signal, e.g., by adjusting a maximum speed threshold according to the selected mode of operation. The processor 40 can be further programmed to actuate the motor to drive with a speed that does not exceed a maximum speed determined according to the mode of operation. Alternatively or additionally, the processor 40 may receive a signal from the mobile computing device 52 or any other device and select the mode of operation according to the received signal. Additionally, the device 10 may include any other modes of operations selectable through the input element 84. Alternatively, the input element 84 can be mounted to any other suitable part of the device 10.

As shown in Figures, the device 10 may include one or more load measuring sensors 44 mounted to, e.g., the top 14, of the platform member 12. The load measuring sensors 44 may be load cells, e.g. strain gauge load cells. A user may stand on the top 14 of the platform member 12 during a ride, i.e. applying weight on the load measuring sensors 44. The load measuring sensors 44 may be used to enable the user to request acceleration, deceleration, steer right, steer left while riding on the ground surface. As an example, controlling the device 10 using load measuring sensors 44 can be done based on a load distribution on the top 14 of the platform member 12. For example, the load measuring sensors 44 may include a front right zone, a front left zone, a rear right zone, and a rear left zone. Alternatively, the load measuring sensors 44 may be an array of load cells, as shown in FIGS. 1 and 2, wherein the load distribution can be calculated based on the force data measured at each of load cell elements in the array of load cells compared to a location of the load cell element compared to a reference point on the top 14 of platform member 12.

Referring to FIGS. 6A-6C, a user may lean forward or backward in order to accelerate or decelerate, and may lean left or right in order to steer to a left or a right direction. The processor 40 may be programmed to receive data from the load measuring sensors 44 indicating a force detected at one or more of the zones, and actuate the motor 26, 28 to move to a direction based on the received force data. For example, when the device 10 with the load measuring sensors 44 with different zones, measures a greater force F_{front} in the front zones than the force Fᵣₑₐᵣ in the rear zones, it may indicate a request for accelerate in a direction D_{forward} as shown in FIG. 6a, or the greater force F_{left} on the left zones than the force F_{right} in the right zones of the load measuring sensors 44 may indicate the request to steer to the left direction of T_{left} as shown in FIG. 6c. Alternatively, the user may ride the device 10 as a skate (not shown), i.e., user may stand toward a right or a left direction on the top 14 of the device. In other words, the user may face to a direction extending between the right wheel 18 and the left wheel 20. In this example, the device 10 may be accelerated, decelerated, or steered in a similar way, as described with respect to FIGS. 6A-6C.

Referring to the example shown in FIG. 3, the device 10 may steer using the driveably connected wheels 18, 20, for example, the right wheel 18 and the left wheel 20 are driveably connected to the electric motor 26 and the second electric motor 28 respectively. The processor 40 may be programmed to actuate the motor drive circuitry 42 to apply different speed and/or different direction of rotation in the electric motors 26 versus the second electric motor 28 in order to steer the device 10. As another example, when the right wheel 18 and the left wheel 20 are both driveably connected to the electric motor 26, the device 10 may include a right clutch adjusting a torque transferred from the electric motor to the right wheel 18 and a left clutch adjusting the torque transferred from the electric motor to the left wheel 20. The processor 40 may be programmed to actuate the right clutch and the left clutch to transfer different amounts of torque to the right wheel 18 versus the left wheel 20, which may cause the device 10 to change the direction of the movement. Additionally or alternatively, swiveling of wheels 22, 24 about the axis A1 or A2 transverse to the platform member 12 controlled by the processor 40 may cause the device 10 to steer.

As an example, in a device 10 with Omni wheels 22, 24, a turn in a right or left direction may cause the Omni wheels slide laterally. This may advantageously provide a smoother turn for the device 10. Alternatively or additionally, the front wheel 22 and/or the rear wheel 24 may pivot about axes A1, A2 transverse to the platform member 12.

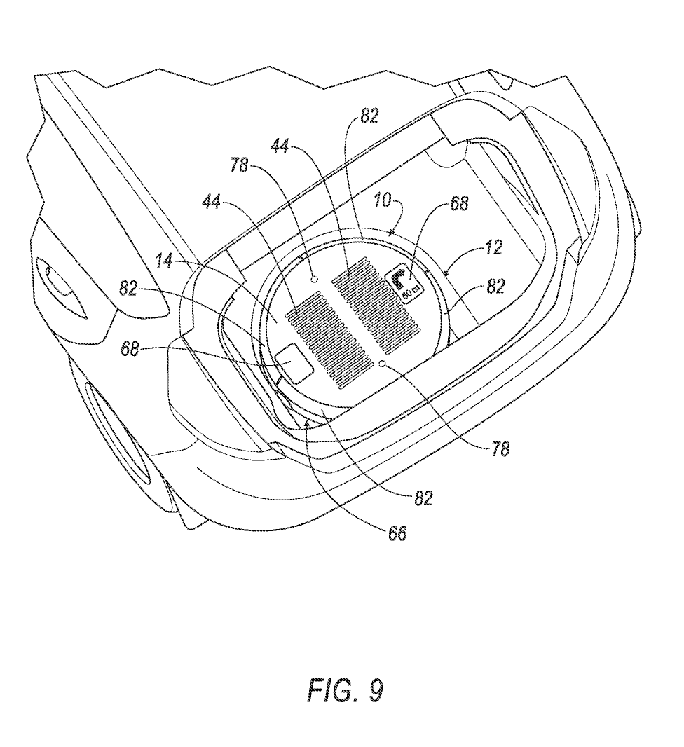

An electrical harness including a plurality of wires may interconnect the batteries 36, the electric motors 26, 28, the electronic controller 38, and the load measuring sensors 44. Additionally, the device 10 may include a charging plug 48 electrically connected to the electrical harness. The charging plug 48 can allow charging the batteries 36 of the device 10. The batteries 36 of the device 10 may be rechargeable and the electronic controller 38 may include a battery charging circuitry 50 to control the flow of electrical energy required for charging the battery 36. Alternatively, the batteries 36 may be charged wirelessly by using a charging coupler instead of the wired charging plug 48, configuring the battery charging circuitry 50 to support inductive charging, and having an inductive charge port connected to a power source, e.g. a vehicle battery. Charging the batteries 36 wirelessly may provide a convenience for the user. The processor 40 of the electronic controller 38 may be programmed to control a charging of the battery 36 when the device 10 is connected through the charging plug 48 to a power source, for example while stored in a spare tire place holder in a trunk of a vehicle as shown in FIG. 9. Alternatively or additionally, the device 10 may be charged in dedicated charging stations around urban areas, at a home, or any other suitable place. Additionally, the device may include a display mounted to the platform member 12, to display a charging level of the batteries 36, for example a segmented ring shape display 82 with four segments may be mounted to the perimeter of the platform member 12. Each of the four segments may be turned on and off to illustrate the charging level of the batteries 36 in five distinct levels of 0%, 25%, 50%, 75%, and 100% charged by illuminating zero, one, two, three or all segments respectively.

In order to avoid a collision of the device 10 with an object on the road having a possibility of rapid deceleration is advantageous. The electronic controller 38 may be programmed to operate the electric motors in a generator mode when the user requests a rapid deceleration, for example when the weight of the user is primarily applied on the rear zones of the load measuring sensors 44. The electric motors in the generator mode resist against the rotation of rotors of the electric motors and thereby may decelerate the device 10. This has the additional benefit that batteries 36 may be charged during a deceleration, if the battery charging circuitry 50 and the electronic controller program support a flow of energy back to the batteries 36, a so called recuperation mode of operation known from hybrid vehicles. Additionally or alternatively, the device 10 may include one or more brakes 80. For example, the brakes 80 may be actuated by the processor 40 when the request of the user to decelerate exceeds a certain deceleration threshold.

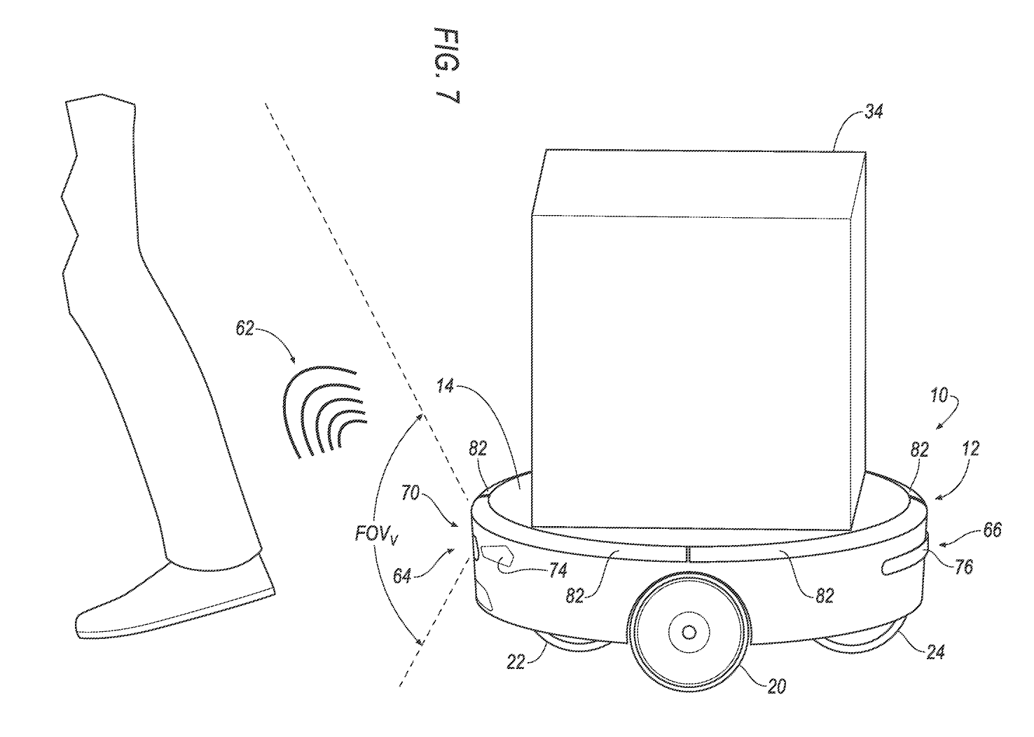

As another example of using the device 10 in a “follow” mode as shown in FIG. 7, the user may put a load 34, e.g. a shopping bag on the platform member 12, and the device 10 may move on the ground surface next to, in front of, or behind the user, without the user riding the device 10. As shown in FIG. 10, a device 10 may have a first location sensor 54, e.g. a global positioning sensor or a location sensor determining a coordinate of the device 10 and a wireless communication circuitry 58, and a mobile computing device 52 may be carried by the user with a second location sensor 56, e.g., a global positioning sensor determining a global coordinate of the mobile computing device 52, with a second wireless communication circuitry 60, e.g., Bluetooth, and the processor 40 programmed to execute a following process as shown in FIG. 11. In short, the mobile computing device 52 of the user device 10 can communicate with the device electronic controller 38 to actuate the device 10 motors 26, 28 to cause the device 10 to move next to, behind, or in front of, the user.

Referring to FIG. 11, the following process includes steps to detect whether the device 10 is in the follow mode, receive a first position (e.g., geo-location using latitude and longitude coordinates as in known) of the device 10, establish a wireless data link 62 to the mobile computing device 52, receive a second position of the mobile computing device 52, calculate a path from the first position to the second position, and move the device 10 along the path from the first position to the second position. To control the movement of the device 10 along the path, the electronic controller 38 may implement various control methods, e.g., proportional integral derivative control, cascade control, fuzzy control, or any other suitable control method. In order to move the device 10 along the path, the electronic controller 38 may need to actuate the device 10 to steer as described above to cause the device 10 to follow a user's walking path.

The user may prefer that the device 10 in the follow mode moves in front of or next to the user. In this case the processor 40 may be programmed to receive navigation information from the mobile computing device 52 and receive commands from the mobile computing device 52 to accelerate, decelerate and steer toward a predetermined destination. Additionally or alternatively, the device may move on a navigation path in an autonomous mode, without the necessity of the user being on the device 10 or in a proximity of the device 10. In this case the acceleration, deceleration and steering of the device 10 is controlled by the processor 40 and/or by the mobile computing device 52 or a cloud server. This may be useful to create a fleet of devices 10 moving on predetermined routes in urban areas creating a so-called hop on hop off transportation mechanism for users. Additionally, a user may use the mobile computing device 52 to send the device 10 autonomously to a certain destination.

The device 10 in the follow mode moving behind the user may additionally or alternatively include a sensor 64, 66, e.g., a camera, for detecting, e.g., objects, in proximity of the device 10, mounted to the perimeter of the device 10 connected through the electrical harness with the electronic controller 38. The sensor 64, 66 has a horizontal field of view FOV_{H} and a vertical field of view FOV_{V} covering at least a portion of a surrounding of the device 10. Alternatively or additionally, the sensor 64, 66 may include a radar, LIDAR, or ultrasound sensors for detecting the objects in proximity of the device 10. Either a second processor in the sensor 64, 66 or the processor 40 in the electronic controller 38 may be programmed to detect the user and calculate the position, e.g., geo-coordinates, of the device 10 relative to the user. The detection of the user may be done using a specific graphical pattern like a QR code on a clothing or accessories of the user or any other feature which enables a camera sensor 64, 66 to distinguish the user from other people around the device 10.

A method for the follow mode as shown in FIG. 11 includes detecting whether the device 10 is in a follow position as shown in block 120, locating the first position of the device 10 as shown in block 122, establishing the wireless data link 62 to the mobile computing device 52 as shown in block 124, receiving the second position of the mobile computing device 52 as shown in block 126, calculating the path from the first position toward the second position as shown in block 128, and moving the device 10 along the path from the first position toward the second position as shown in block 130.

The processor 40 of the electronic controller 38 may be programmed to detect an object in the field of view of the sensor 64, 66, actuate the electric motors 26, 28 to move the device 10 in the direction toward the object or away from the object. The object detected by the device 10 may be a pattern in the field of view of the sensor 64, 66.

As another example, to avoid a collision between the device 10 and the user, while following the user, the processor 40 may send a request to stop when the device 10 reaches a predetermined minimum proximity, i.e., distance, threshold. The device 10 may move again after the user walks forward and the distance between the device 10 and the user exceeds the predetermined minimum distance. As shown in FIG. 11, the method may include calculating an intermediate position on the path as shown in block 132. the intermediate position having a distance to the second position at least equal to the minimum proximity threshold, and stopping the device 10 at the second position as shown in block 134.

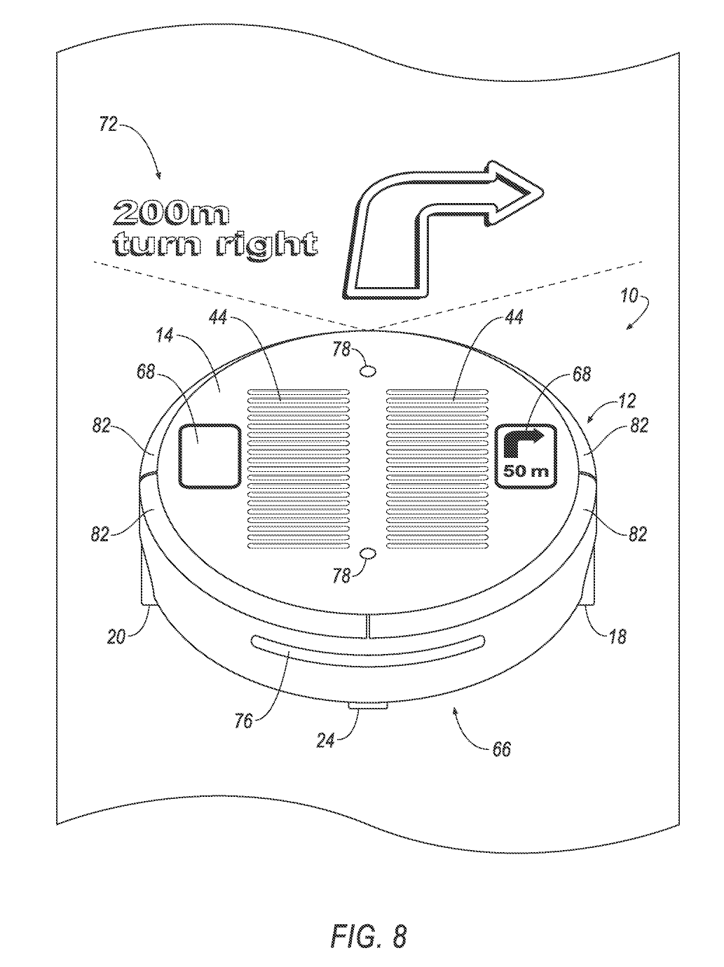

As shown in FIG. 8, the device 10 may include one or more display elements 68 mounted to the platform member 12. The display elements 68 may provide information to the user, e.g. when the device 10 moves in the autonomous mode and the user stands on the device 10, the displays may indicate a next change in the direction of movement to the user. Alternatively or additionally, the device 10 may include a projector 70 having a projection axis extending from the platform member 12 which projects information in visual form 72 on a surface, e.g. on the ground surface as shown in FIG. 6.

For better visibility, the device 10 may include a plurality of light elements mounted to the perimeter of the device 10, e.g. a front light 74 and/or a tail light 76.

As shown in FIG. 8, the device 10 may have a hole 78 on the top 14 of the platform member 12 to provide a possibility of supporting an umbrella or the like of the user. This may give an improved feeling of stability to the user. This can be used also for holding a stick used by the user as a walking assistance. Additionally or alternatively, a pole may be mounted to the top 14 or the chassis 13 of the platform member 12 which can be held by the user for better stability.

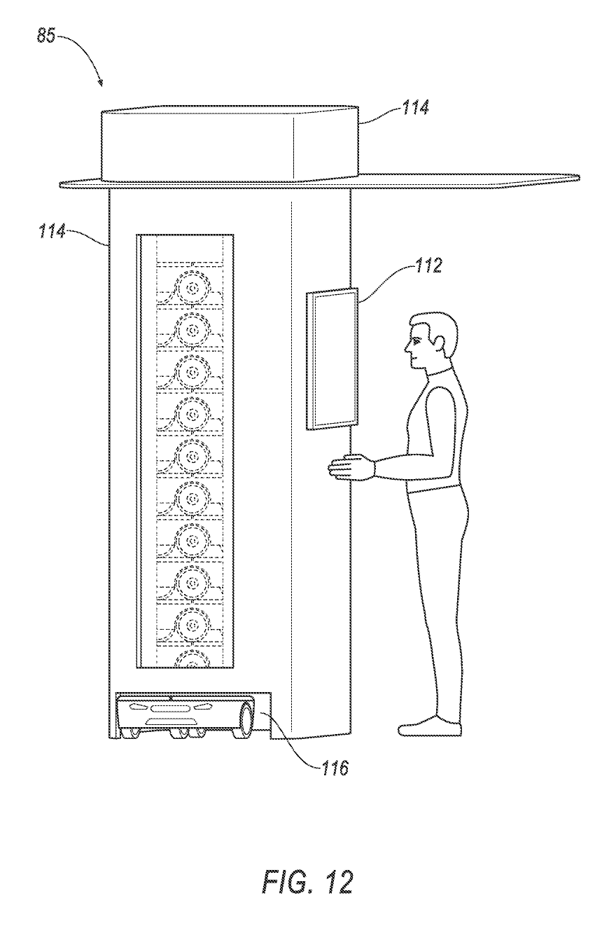

In order to store and/or charge the device 10, e.g., in a crowded downtown area, a storage system with charging capability can be provided. With reference to FIGS. 12-16, a system 85 that can store multiple devices 10 includes a storage apparatus 86 that includes a charging port 88, a handling device 92, and a processor 110. The processor 110 is programmed to output a signal to the handling device 92 to select the storage apparatus 86 for a transportation device 10, place the transportation device 10 in the storage apparatus 86, and then activate the charging port 88 to charge the transportation device 10.

The storage and charging system 85 is described herein according to examples in which one or more example transportation devices 10, described above, may be stored and/or connected for charging. However, it is to be understood that the storage and charging system 85 could include principles and/or structures suitable for storing and/or charging other transportation devices.

In one example shown in FIG. 12, the storage system 85 can receive a device 10 from the user for storage and/or charging, output a status of one or more stored devices 10, and/or return a stored device 10 to the user. The storage system 85 may further include a cover 114, e.g., a plastic, glass, or metal cover, a user interface 112, e.g., a touch screen, and an opening 116. The device 10 may enter or exit the storage system 85 through the opening 116. The user may communicate with the storage system 85 via the user interface 112. Alternatively or additionally, the storage system 85 may include a wireless communication interface 118 to communicate with, e.g., a mobile computing device 52 of the user. Such storage systems 85 may be placed on a road side, inside a shopping mall, etc.

In order to store multiple devices 10, the storage system 85 may include multiple storage apparatuses 86. A device 10 can be stored in each storage apparatus 85. Storage apparatuses may be shelves arranged in a vertical stack, e.g., to save space in a crowded city downtown.

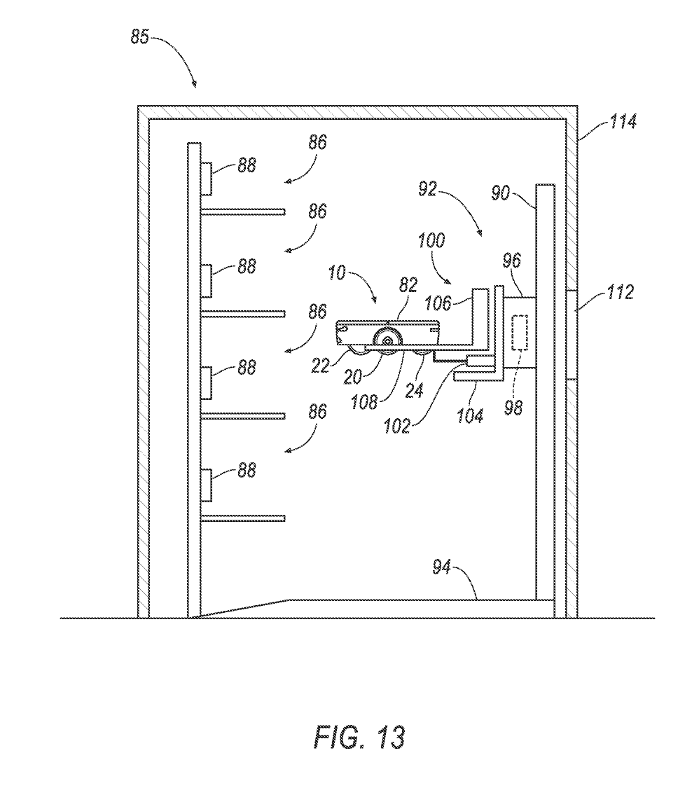

As shown in FIG. 13, the storage apparatuses 86 include charging ports 88. The charging ports 88 may be electrically and mechanically connectable to the devices 10, e.g., via a socket, to charge batteries 36. Alternatively, a charging port 88 may include a wireless charging component such as an inductive coil to charge the devices 10 batteries 36 via magnetic induction. An area inside the storage apparatus 86 where a wired or wireless connection between the storage apparatus 86 charging port 88 is provided, e.g., in induction range of the inductive coil, is referred to as the charging position.

The handling device 92 may include a base 94, a guide 90 supported by the base 94, a lifting apparatus 96 slideably mounted to the guide 90, and a holder device 100 mounted to the lifting apparatus 96.

The base 94 may include metal sheets, metal beams, etc. connected together, e.g., welded. The base 94 may be shaped such that the devices 10 entering/exiting the storage system 85 through the opening 116 can move on the base to an area accessible to the handling device 92, e.g., the holder device 100.

The guide 90 may include tracks or other mechanisms allowing the lifting apparatus 96 to slide along the guide 90 while mechanically engaged with the guide 90. When the storage apparatuses 86 are stacked vertically, the guide 90 may be parallel to the vertical stack of the storage apparatuses 86.

As shown in FIG. 13, the guide 90 may be mounted to the base 94. Alternatively, the guide 90 may movable relative to the base 94. For example, the storage apparatuses 86 may be stacked in multiple vertical stacks or stacked horizontally. Thus, the guide 90 may be mounted to a horizontal moving actuator movably engaged with the base 94, e.g., via a second guide. Such horizontal moving actuator may receive a signal from the processor 110 to move the guide 90 relative to the base.

The lifting apparatus 96 may be a solid rectangle engaged with the guide 90 via sleeves, linear bearings, etc. The lifting apparatus 96 may be formed of metal or other hard materials. Alternatively, the lifting apparatus 96 can have other shapes or structures supported by the base 94 and suited for lifting the devices 10.

The handling device 92 may include a lifting actuator 98 mechanically coupled to the lifting apparatus 96, e.g., an electrical or pneumatic drive, engaged with the guide 90. The storage system 85 processor 110 may output a signal to the lifting actuator 98 to slide the lifting apparatus 96 along the guide 90. The lifting actuator 98 may move the lifting apparatus 96 in accordance with the received signal. For example, the storage apparatuses 86 may be numbered 1 to 20, and the received signal may indicate a fifth storage apparatus 86. The lifting apparatus 96 may move to a position in front of the fifth storage apparatus 86 based on the received signal. Alternatively, the received signal may indicate a move to a pickup or deposit location, e.g., to pick up a device 10 inserted through the opening 116 and resting on the base 94.

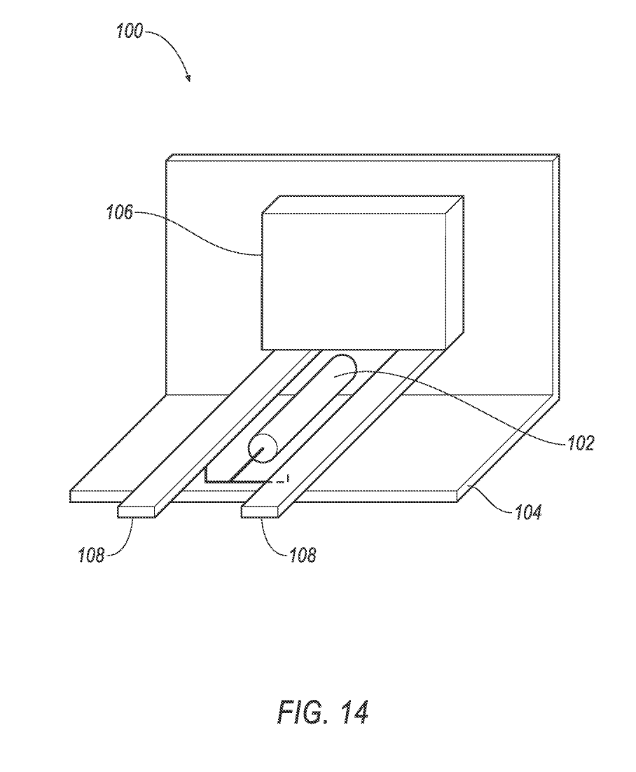

As shown in FIGS. 13-14, the holder device 100 can include an attachment 104 mounted to the lifting apparatus 96, and a carrier 106 moveably mounted to the attachment 104.

The carrier 106 may be shaped so as to pick up, carry, and release the devices 10, e.g., the carrier 106 may have a shape of a fork. A distance between the fork shaped carrier 106 tines 108 may be less than a diameter of the transportation device. That is, the device 10 bottom 16 may be supported by the tines 108 while the device is carried by the carrier 106.

The carrier 106 can be supported by the lifting apparatus 96, e.g., via the attachment 104. In order to place/remove the device 10 in/from the storage apparatus 86, the carrier 106 may be movable relative to the attachment 104, e.g., via a slide. Additionally, the holder device 100 may include a holder actuator 102, e.g., an electrical linear actuator, to move the carrier 106 relative to the attachment 104. The holder actuator 102 may couple the carrier 106 to the attachment 104. The carrier 106 may be in a retracted position when the carrier 106 is adjacent the attachment 104, e.g., the carrier 106 touching the attachment 104 or closest to the attachment 104. The carrier 106 may be in an extended position when the carrier 106 is spaced away from the attachment 104, e.g., an end position of the linear holder actuator 102, e.g., actuator 102 fully extended, or a charging position in the storage apparatus 86 allowing the device 10 supported by the carrier 106 being connectable to the storage apparatus 86 charging port 88.

The storage system 85 processor 110 may be further programmed to control the holder actuator 102 to move the carrier 106 between the retracted position and the extended position. For example, while the carrier 106 is in the retracted position, the lifting actuator 98 vertically moves the carrier 106 in front of the storage apparatus 86 based on a signal from the processor 110. Then, the processor 110 may output a signal to the holder actuator 102 to move the carrier 106 to the extended position to place the device 10 in the storage apparatus 86. Additionally or alternatively, the processor 110 may be programmed to place the device 10 at a charging position of the storage apparatus 86.

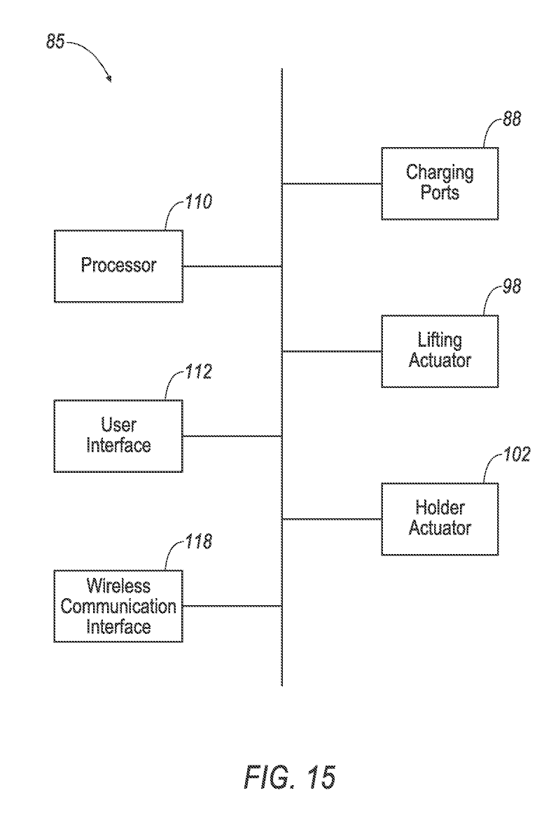

As shown in the block diagram of FIG. 15, the processor 110 may electrically communicate, e.g., via Ethernet or Process Field Bus (PROFIBUS), with the user interface 112, the lifting actuator 98, the holder actuator 102, the wireless communication interface 118, and the charging ports 88.

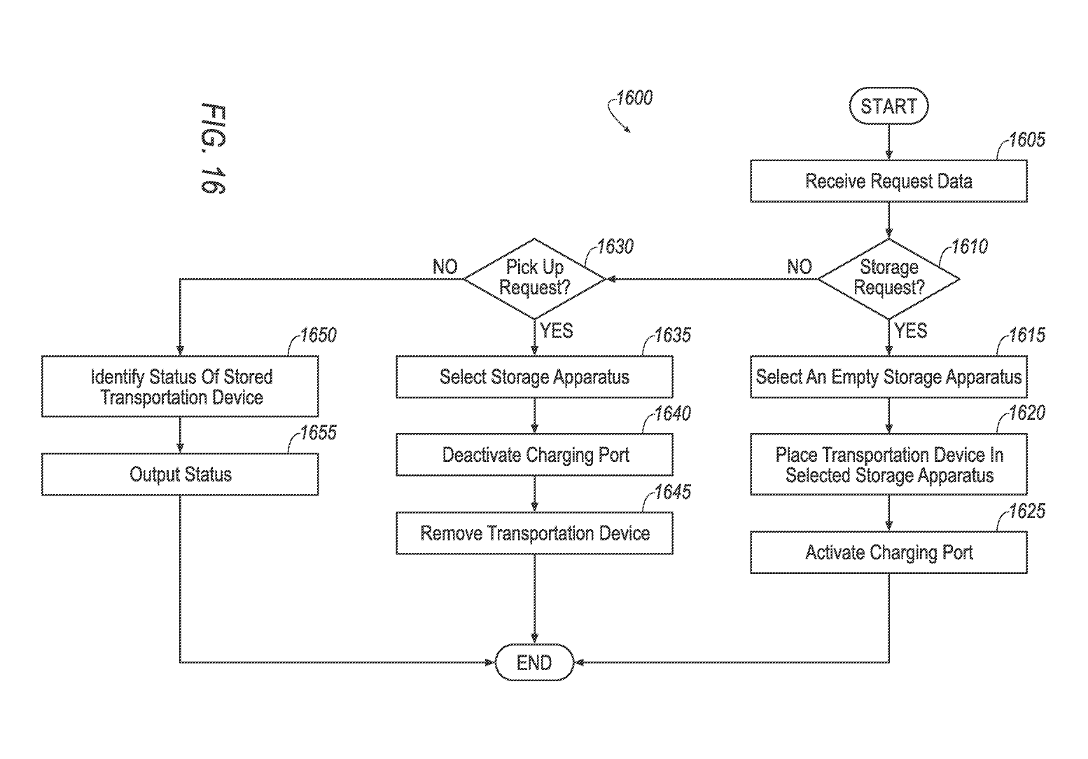

The process 1600 of FIG. 16 begins in a block 1605, in which the processor 110 receives a request from, e.g., the user interface 112 or a mobile computing device 52.

Next, at a decision block 1610, the processor 110 determines, based on the received request, whether the received request is a storage request, i.e., a request to store a device 10 in the storage system 85. If so, a block 1615 is executed next; otherwise, the process 1600 proceeds to a block 1630.

In the block 1615, the processor 110 may select an empty storage apparatus 86 based on the received data, e.g., based on size of the device 10 provided in the received request.

Next, in a block 1620, the processor outputs signals to the lifting actuator 98 to lift the device 10 from the base 94 and place in the storage apparatus 86 selected at block 1615. For example, the processor 110 may be programmed to output a signal to the lifting actuator 98 to move the lifting apparatus 86 to the base 94, e.g., a directional speed value such as −10 m/s for downward movement of the lifting apparatus 96. The processor may further be programmed to then output a signal to the holder actuator 102, e.g., 1, to unretract the carrier 106 to the extended position, e.g., the tines 108 placed under the device 10, and then output a signal, e.g., −1, to the holder actuator 102 to move the carrier 106 carrying the device 10 to the retracted position, to then output a signal, e.g., 10 m/s, to the lifting actuator 98 to move the lifting apparatus 86 upward in front of the storage apparatus 86 selected at block 1615, and further to then output a signal, e.g., 1, to the holder actuator 98 to move the carrier 106 to the extended position to place the device in the selected storage apparatus. Additionally, the processor 110 may be programmed to couple the device 10 with a respective charging port 88 of the selected storage apparatus 86, e.g., by placing the device 10 at a charging area in the storage apparatus 86. For example, the charging area may be a specific location of the storage apparatus 86 may provide best induction for an induction charging. The processor 110 may receive data from sensors such as cameras mounted in the storage system 85 to place the device 10 in the expected charging area.

Next, in a block 1625, the processor 110 may activate the charging port of the selected storage apparatus 86, e.g., turning on a relay providing power to the charging port 88.

In the decision block 1630, which may follow the block 1610, the processor 110 determines whether the received request is a pickup request, i.e., a stored device 10 is requested to be picked up. If yes, a block 1635 is executed next. Otherwise, the process 1600 proceeds to a block 1650.

In the block 1635, the processor 110 selects a storage apparatus 86 holding a device 10 to be given to the user. The processor 110 may select the storage apparatus 86 based on the received request data, e.g., identification of a specific device 10.

Next, in a block 1640, the processor 110 may deactivate the charging port 88 of the selected storage apparatus 86, e.g., turning off a relay providing power to the charging port 88.

Next, in a block 1645, the processor 110 may remove the device 10 from the selected storage apparatus 86 and place the device 10 on the base 94, i.e., as described above with respect to the block 1620.

In the block 1650, which may follow the block 1630, the processor 110 identifies a status of charging of a device 10 based on the received request data. For example, the request data may include the identification of a device 10 stored. The processor 110 may identify the storage apparatus 86 holding the specific device 10, e.g., a memory of the processor 110 may contain history information about allocation of stored devices 10 to the storage apparatuses 86.

At block 1655, the processor 110 may output the status identified at block 1650. The output status may be displayed on the user interface 112 or a mobile computing device 52.

Following blocks 1625, 1645, or 1655, the process 1600 ends.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising:
a storage apparatus that includes a charging port;
a handling device; and
a processor programmed to:
output a signal to the handling device to select the storage apparatus for a transportation device;
place the transportation device in the storage apparatus; and
then activate the charging port to charge the transportation device.

2. The system of claim 1, wherein the selected storage apparatus is one of a plurality of storage apparatuses.

3. The system of claim 2, wherein the storage apparatuses are arranged in a vertical stack.

4. The system of claim 1, wherein the charging port is mechanically and electrically connectable to the transportation device.

5. The system of claim 1, wherein the processor is further programmed to couple the transportation device with a respective charging port of the selected storage apparatus.

6. The system of claim 1, wherein the processor is further programmed to:
receive a pickup request for a stored transportation device;
identify the selected storage apparatus based at least partially on the received pickup request; and
output a signal to the handling device to remove the stored transportation device from the selected storage apparatus.

7. The system of claim 1, wherein the processor is further programmed to:
receive a status request for a stored transportation device; and
output a status information based at least partially on the received status request.

8. The system of claim 1, wherein the handling device further includes a base, a guide supported by the base, a lifting apparatus slideably mounted to the guide, and a holder device mounted to the lifting apparatus.

9. The system of claim 8, wherein the selected storage apparatus is one of a plurality of storage apparatuses arranged in a vertical stack, and the guide is substantially parallel to the vertical stack of the plurality of the storage apparatuses.

10. The system of claim 8, further including a lifting actuator mechanically coupled to the lifting apparatus, wherein the processor is further programmed to output a signal to the lifting actuator to slide the lifting apparatus along the guide.

11. The system of claim 8, wherein the holder device further includes an attachment mounted to the lifting apparatus, and a carrier moveably mounted to the attachment.

12. The system of claim 11, wherein the carrier is movable relative to the attachment.

13. The system of claim 12, wherein the carrier is linearly moveable relative to the attachment.

14. The system of claim 11 wherein the carrier has a fork.

15. The system of claim 14, wherein a distance between tines of the fork is less than a diameter of the transportation device.

16. The system of claim 11, wherein the carrier is adjacent the attachment when the carrier is in a retracted position, and the carrier is spaced away from the attachment when the carrier is in an extended position.

17. The system of claim 16, further including an actuator mechanically coupled to the carrier, wherein the processor is further programmed to control the actuator to move the carrier between the retracted position and the extended position.

18. The system of claim 1, wherein the processor is further programmed to place the transportation device at a charging position of the selected storage apparatus.
